(19) United States
(12) Patent Application Publication
(10) Pub. No.: US 2007/0163143 A1
(43) Pub. Date: Jul. 19, 2007

(54) Device for the degassing of a disk-form substrate

(76) Inventor: Bart Scholte van Mast, Schweiz (CH)

Correspondence Address: NOTARO AND MICHALOS, 100 DUTCH HILL ROAD, SUITE 110, ORANGEBURG, NY, 10962-2100, US

(21) Appl. No.: 11/646,139

(22) Filed: Dec. 27, 2006

(30) Foreign Application Priority Data
Jan. 18, 2006 (CH) 00070/06

(51) Int. Cl. F26B 5/04

(52) U.S. Cl. 34/406

(57) ABSTRACT

A device for degassing a substrate plate in an evacuated environment with two substantially flat, parallel bodies spaced at a distance smaller than their longitudinal extent forming an interspace with the substrate located between the bodies and these projecting beyond the substrate at least in the margin region, wherein in at least one of the bodies a gas delivery is disposed for generating a laminar gas flow in the interspace along the bodies and the substrate in the radial direction toward the periphery of the bodies, and that here a pumping port is provided for pumping off the gas flow.

### FIELD AND BACKGROUND OF THE INVENTION

The invention relates to a device for degassing a disk-form substrate as well as to a method for degassing a disk-form substrate.

In modern vacuum process facilities circular flat substrates or workpieces, which are also referred to as wafers, are surface-treated, for example coated, etched, cleaned, thermally treated, etc. in such fully automated vacuum process systems. In order to automate such processes and to be able to carry out multi-stage processes in different facility areas, automated transport systems, a type of handling robot, are utilized herein. In particular the treatment of semiconductor wafers requires in such processes a very high quality of treatment, such as in particular high cleanness, high precision and careful handling of the substrates. Due to the cited high requirements such facilities preferably include a lock chamber, where the wafers are moved from an atmospheric environment into a vacuum chamber and subsequently into a process station or, as a rule, successively into several process stations, in order to be able to carry out the required surface treatment. The wafers are herein transferred with the aid of a transport device preferably in a horizontal transport plane from the lock chamber into the process chamber, wherein, after depositing the wafers in the process chamber, the latter is closed, as a rule, in order to be able to carry out the process in it under the required vacuum process conditions. If several process steps are required, the wafer is again transported in the same manner out of the pure process chamber and transported into a different process chamber for the next process step. Especially preferred facility types in this connection are so-called cluster systems. In such systems the lock chamber and the process chamber, or the several chambers, are arranged peripherally about the substantially central transport chamber. If more than one lock chamber and, in particular, several process chambers are available, these chambers are arranged in a type of star-shaped configuration about the central transport chamber. The transport device in this case is located in this central transport chamber and has access, on the one hand, to the at least one lock chamber and, on the other hand, to the process chambers. Between transport chamber and the remaining chambers conventionally and preferably a so-called lock valve is disposed in order to be able to seal the chambers off against one another during the lock process or during the process step. During the transport of a wafer the transport device subsequently reaches accordingly through the open lock gate in order to deposit the water at the desired site. Lock chambers and partitionable process chambers serve for the purpose of being able to partition off different atmospheres against one another, on the one hand, and, in particular, [to prevent] entrainments of undesirable impurities which would lead to contaminations in the working processes.

In such vacuum processes, as in particular for the deposition of thin layers, the cleanliness and the quality of the substrate surface play an important role and affect the layers, for example deposited, highly significantly in terms of quality. Important substances, which may be found on a substrate in a vacuum environment are water or water vapor and organic materials. Such contaminating substances are adsorbed on the surface of the substrate and are conventionally removed by increasing the vapor pressure of this contaminating substance, for example by increasing the temperature. Such a temperature increase is generated for example by infrared radiation or by heating the substrate via conduction, thus heat conduction. When the increased temperature has been reached at the substrate, an additional effective pumping mechanism is necessary in order to be able to pump off the impurities, which are now in the gaseous form, streaming from the substrate surface. This is customarily achieved thereby that pumping to low vacuum pressures is carried out.

An example of the desorption behavior of a metal surface saturated with water vapor is depicted in FIG. 1. Curve 1 shows the behavior of the dwelling time T₀ of the water vapor on the metal surface as a function of the surface temperature T_{w} of the substrate. The dwelling time T₀ as a function of the substrate temperature T_{w} of an adsorbate on the surface follows the formula:

tau(T_{w})=tau₀·ε^{E abs/N A·k b·T}

wherein N_{A} is Avogadro's constant, k_{b} Boltzmann's constant, tau₀ the characteristic vibration period of solid body material (approximately 10⁻³ sec) and E_{ads} the adsorption energy of water on metal (approximately 10⁵ j). A similar curve is valid for the behavior of substrates in vacuum systems. FIG. 2 depicts a configuration with two parallel plates in which the one plate is the substrate 2 and the other plate represents the environment 3. A gas flow 4 to the substrate and a gas flow 5 away from the substrate may be assumed. When the system reaches equilibrium after a certain dwelling time, a maximal gas removal efficiency can be attained based on the temperature difference between the substrate 2 and the environment 3. Herein the gas removal will not change independently of the length of time the process is continued. To shift the equilibrium toward the lowest adsorbate concentration on the substrate, as stated, pumping-off takes place in known manner via a pumping configuration, here with pumping port 6 shown schematically in FIG. 3. In this case the adsorbate concentration is proportional to the temperature equilibrium and the adsorbate actually removed from the system. This is lastly dependent on the pumping capacity, the pumping port 6 and the time. A greater pumping capacity or a longer pumping time consequently leads to better results. However, as already stated, this leads to the necessity of large pumps, long pumping times or high temperatures. Ultrahigh-vacuum pumps and temperatures about 400° Celsius are not unusual when used in such systems, in order to attain a sufficiently short, for example lasting 30 s, process time for the degassing cycles.

In systems based on radiation heating, high energy values must be expended in the system in order to compensate the low heating efficiency of such system. Such a system can passably function as a single degassing unit. As a degassing component or module which is embedded in a larger system, the cooling requirements for such a system lead to very expensive and complicated arrangements. Moreover, the substrate in many cases is one of the coldest elements in its environment and consequently does not exhibit good degassing behavior.

Conductive heating dispositions or heating dispositions with heat conduction are per se a better approach. The substrate is here conventionally clamped onto a heated body, and between body and substrate a gas is introduced in order to generate heat conduction from the body onto the substrate. The pumping system is utilized to remove the contaminations which originate from the side not exposed to the contact gas.

Both of these techniques are high vacuum methods. The effectiveness of the system is substantially determined by the efficiency of the pumping system. The better the vacuum in the environment, the better is the degassing effect of the system. However, this leads to very large and very expensive pumping systems. In addition, longer working times for the removal of the adsorbate are required. This, in turn, leads to very long undesirable process times, which lower the economy of the production system. When using higher temperatures, the process time could be shortened, which, however, is undesirable in many cases or not possible at all due to the sensitivity of such substrates.

Object of the present invention is the elimination of the above listed disadvantages of prior art. The object lies in particular in realizing a device and a method for degassing disk-form substrates, in particular semiconductor disks, which have high effectiveness and allow shortening the working time while handling the substrate carefully, with which high economy in the production process can be attained.

The aim is attained according to the invention through a device for degassing disk-form substrates as claimed in claim 1 and with a method as claimed in claim 13. The dependent claims define further advantageous embodiments.

The solution of the present task consists according to the invention therein that the device for the degassing of a disk-form substrate, such as in particular of a semiconductor wafer 2, in an evacuated environment substantially comprises flat parallel bodies, which are disposed at a spacing from one another and wherein the spacing is less than the longitudinal extent or the diameter of the body and that thereby an interspace is formed in which the substrate is disposed between the bodies and the bodies project at least beyond it in the margin region, wherein in at least one of the bodies a gas delivery is disposed for generating a laminar gas flow in the interspace along the bodies and along the substrate in the radial direction toward the periphery of the bodies, and that here a pumping port is provided for pumping off the gas flow.

The geometric formation of the configuration and the adjustment of the gas flow conditions should take place such that between the plate-form bodies over the substrate surface a gas streaming is attained which is in the laminar range and that the gas volume between the bodies is replaced several times over the process time. Laminar gas flow is established when the movement of the gas parallel to the substrate surface is gas flow-driven and any mass transfer perpendicularly to the substrate is diffusion driven. Such conditions can be established thereby that, at given dimension of the substrate and consequently given dimension of the bodies, whose interval or the gap width of the formed interspace is selected such that with the corresponding formation of the gas delivery and the pressure conditions, which determine the gas quantity together with the pumping capacity, the desired laminar flow occurs. For the degassing process the substrate is additionally heated with a heating system, which is disposed for example within one or both plates, in order to additionally accelerate the degassing process. With such a degassing device the degree of degassing can be significantly improved and/or the duration of the degassing can be significantly shortened, for example by more than a factor of 2. In a typical treatment facility for semiconductor wafers the process time for the individual treatment steps critically determines the throughput of the facility, and consequently its economy. Here that process step is in particular determinative which lasts the longest. So far this has often been the process step which was necessary for the degassing of the substrate. A simple process, as in principle the degassing represents, should not be determinant and limiting with respect to the facility throughput. In the case of practical embodiments of such semiconductor process systems such a degassing step should be completed for example within approximately 30 s, such that for the remaining process steps or for the process cycle approximately 50 s are made possible. The 20 s time difference is required for the pumping process and the transport or the handling, respectively, of the substrate.

The various features of novelty which characterize the invention are pointed out with particularity in the claims annexed to and forming a part of this disclosure and are entirely based on the priority application, Swiss Patent Application 0007/06 filed Jan. 18, 2006. For a better understanding of the invention, its operating. advantages and specific objects attained by its uses, reference is made to the accompanying drawings and descriptive matter in which a preferred embodiment of the invention is illustrated.

### BRIEF DESCRIPTION OF THE DRAWINGS

In the following the invention will be described in further detail by example and in conjunction with schematic Figures. Therein depict:

FIG. 1 is a graph that depicts desorption behavior of a metal surface saturated with water vapor;

FIG. 2 depicts a configuration with two parallel plates;

FIG. 3 is a view similar to FIG. 2 but with a pumping port shown schematically;

FIG. 4 is a segment in cross section of parallel disposed flat substrate and flat body disposed at a spacing therefrom, with intermediate laminar gas flow according to the invention;

FIG. 5 is a view of a configuration according to the invention shown schematically in cross section;

FIG. 6 is a perspective view of an example of the gas delivery;

FIG. 7 is a cross sectional detail of a gas delivery opening in cross section according to the gas delivery according to FIG. 6;

FIG. 8 is a schematic cross section of a degassing disposition with heating elements located in both bodies;

FIG. 9 is a schematic cross section of a degassing disposition with a heating element located in the body, on which the substrate rests;

FIG. 10 is a schematic cross section of a degassing disposition with a heating element located in the body opposite the substrate surface;

FIG. 11 is a graphic representation of the residual water content on the substrate shown as a function of the temperature with laminar gas flow disposition corresponding to the invention and without gas flow corresponding to prior art;

FIG. 12 is a view similar to FIG. 8 of another embodiment of the invention; and

FIG. 13 is a view similar to FIG. 8 of a still further embodiment of the invention.

### DESCRIPTION OF THE PREFERRED EMBODIMENTS

According to the improved method for effectively purging the adsorbate, in accordance with the present invention the adsorbate concentration in the proximity of the substrate surface is affected such that the adsorbate flow 4, as depicted in FIG. 2, directed against the substrate 2, is as much as possible removed or reduced and thereby the stated equilibrium is shifted.

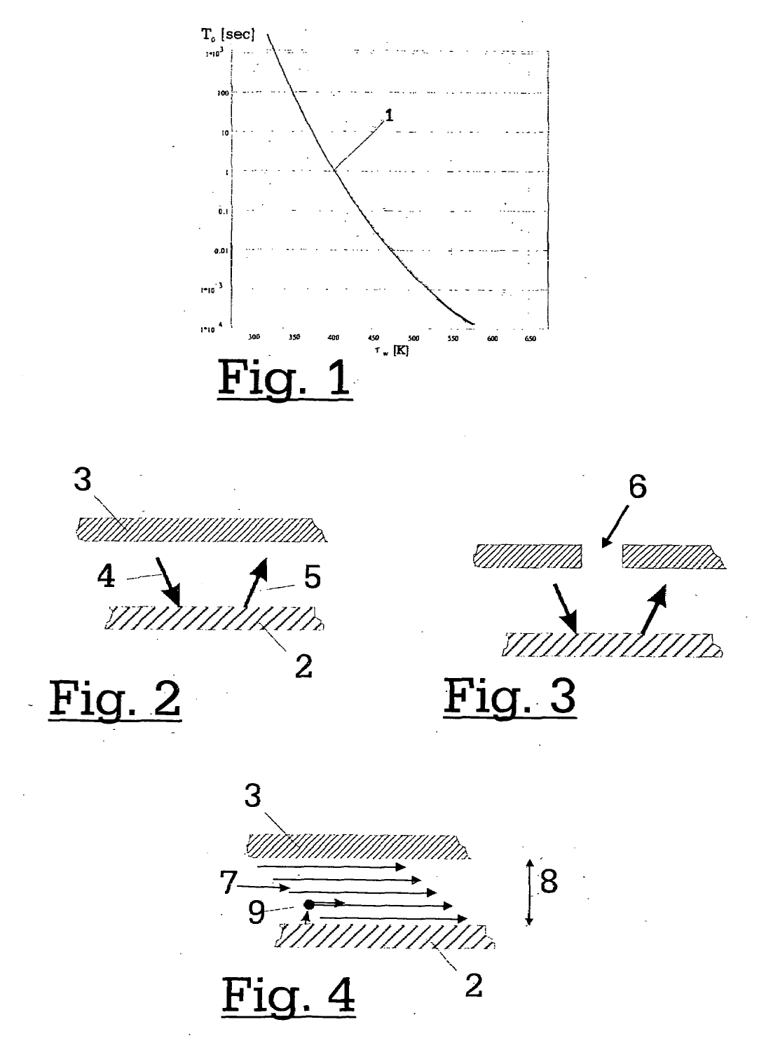

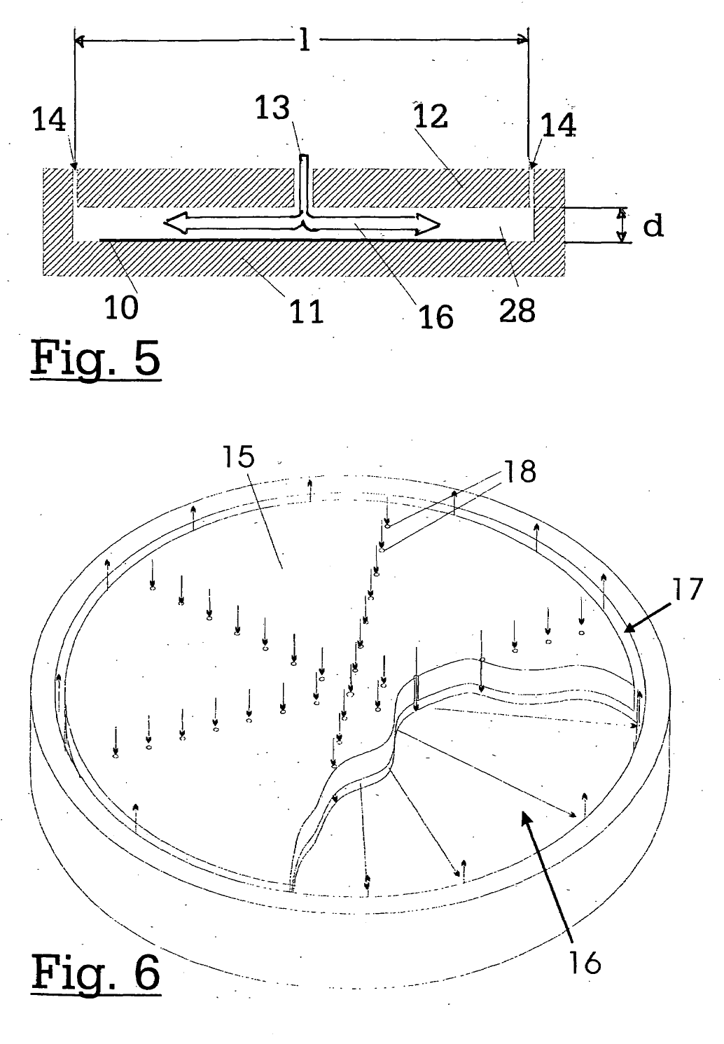

If in the proximity of the substrate surface of substrate 2 a gas flow of non-absorbing gas 7 is set up with a laminar or turbulent gas flow regime, the previously introduced model with the equilibrium consideration changes significantly. Such a configuration is shown schematically and in cross section in FIG. 4. If the gas flow between two plates is laminar or turbulent, the free path length of the gas particles in the gas is significantly smaller than the characteristic dimension of the system, thus the distance 8 between substrate 2 and the opposing plate 3. This applies also to the short free path length for evaporating adsorbates from the surface of the substrate, with which each material 9 evaporating from substrate 2 becomes a part of the gas flow 7 as soon as it has left the surface of the substrate. As soon as the temperature of the substrate is brought to a value at which the dwelling time of the adsorbate is very short in comparison to the typical process time, it may be assumed that the adsorbate forms elastic collisions with the surface of the substrate and hereby forms an integral component of the inert gas flow encompassing the substrate. This is the case if, for example, for a 30 s process step the dwelling time reaches hundredths of seconds. Such dwelling times can be attained if temperature values are reached, for example, corresponding to curve 1 shown in FIG. 1, thus temperatures of 430 to 480° Kelvin, which corresponds approximately to 160 to 200° Celsius. When these temperatures have been reached and the desorbed species becomes an integral part of the gas flow 7, the transport away of this species now depends only on the gas flow rate. For this reason a gas flow must be generated which generates a complete gas replacement in the volume in the proximity of the substrate within the selected process time. It is advantageous to carry out the gas replacement several times, preferably more than 5-fold, in order to ensure that the adsorbates are completely removed. Inert gases should preferably be used to generate a gas flow, argon being especially favorable.

In an advantageous embodiment of the invention the substrate 10, which is to be degassed, is located between two bodies 11, 12 with extension I which are spaced apart at a distance d and form here an interspace 28, as shown in FIG. 5 in cross section. The substrate 10 is to be brought to an increased temperature, such as for example 200° Celsius, by means of a heating appliance. Between the at least one body 11, 12 and the substrate 10 a gas flow 13 is to be generated, which forms a laminar gas flow over the entire surface of the substrate 10. In the margin region of the substrate 10, or of the at least one body 11, 12, a pumping port 14 is located, which advantageously encompasses the substrate 10, through which the gas, together with the contamination gas, is pumped off and thereby removed out of the system. For round substrates 10, such as for the preferred semiconductor wafers or storage disks, the gas for the gas delivery 13 can be sprayed in through a body 15 with openings 18, which are disposed such that a radial flow 16 from the center toward the periphery is established. This disposition may be combined with a circular pumping port 17 located at the periphery or with several openings, which are circularly arranged. With this circularly disposed pumping port 17 the pumping rate of the pump configuration is determined or limited, such that the gas flow formation is essentially determined by the gas flow and not by the pump dimensions, as is shown for example in the three-dimensional illustration according to FIG. 6.

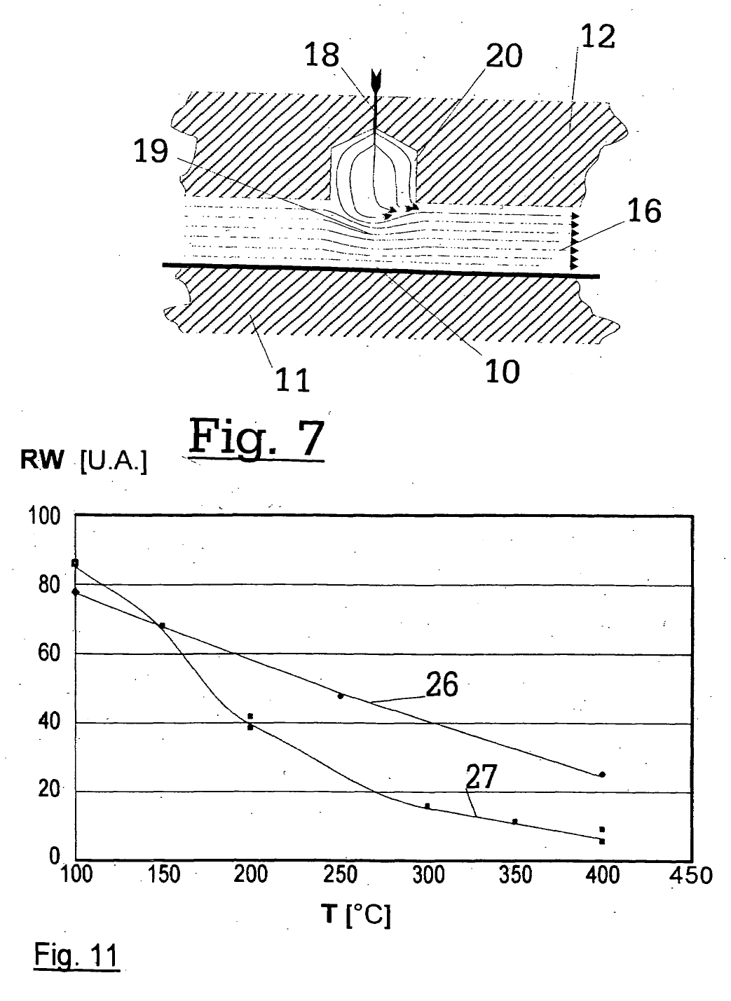

The gas flow between the substrate 10 and the body 11, 12 should as much as possible be undisturbedly laminar, in order to minimize the contamination gas flow back to the substrate 10. This raises special requirements of the formation of the gas injection point(s) in the region above the substrate 10. An example of a preferred inlet configuration with a gas delivery point is shown in cross section in FIG. 7. Such gas injection points should generate a predetermined defined gas flow and these should therefore be formed such that this defined gas flow per injection point is self-determining through its formation. To fulfil this requirement, for the gas injection points very small openings 18 are provided in order to be able to attain a high gas rate in this region. Thereby, in turn, in these regions the laminar gas flow formation or distribution 19 is significantly disturbed. As stated, this should be avoided and it is necessary to reduce the rate of the gas sprayed-in through the opening 18 thereby that the opening 18 with very small diameter opens out into a region with substantially expanded diameter 20, which forms the outlet of the nozzle terminating in the region of the laminar gas streaming 16. With the aid of this measure the sprayed-in gas can be lowered to a velocity level which does not significantly disturb the laminar streaming of the gas flow in the proximity of the substrate 10.

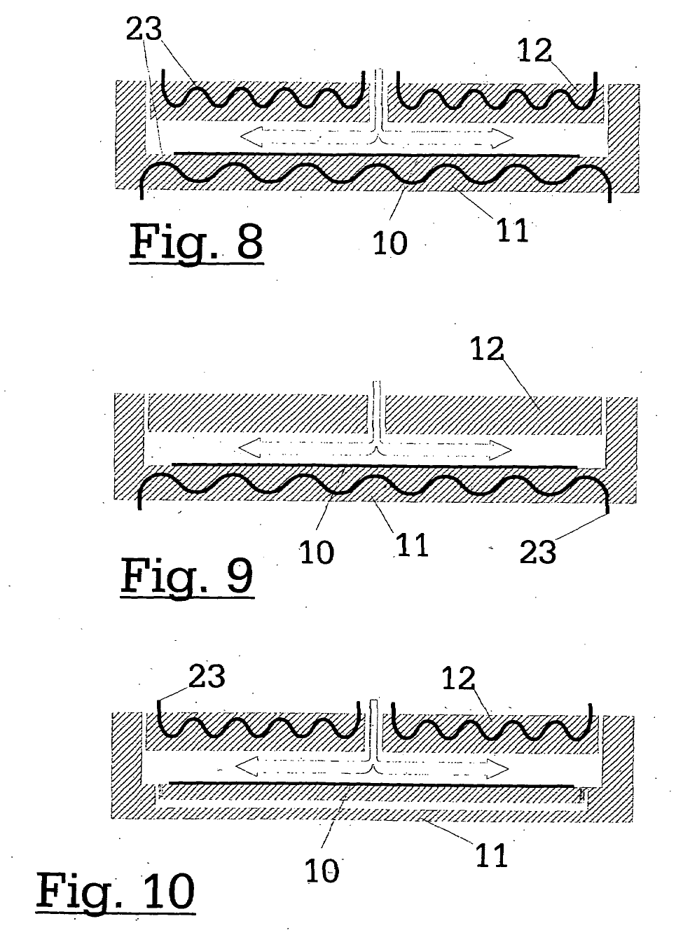

In a further embodiment of the invention both bodies 11, 12 encompassing the substrate 10 are provided with heating elements 23, in order to heat the bodies 11, 12 and thereby to heat the substrate 10, as is schematically depicted in FIG. 8 in cross section. In a further variant according to FIG. 9 only the one body 12 is heated, on which the substrate 10 rests and which consequently is in contact with this body. In a further preferred variant corresponding to the illustration according to FIG. 10, the body 11, 12 opposing the substrate is preferably heated, the substrate 10 itself being disposed thermally floating, thus substantially insulated, on the subjacent body 11. With this disposition an especially simple embodiment of a degassing station can be realized.

A characterization of the advantageous results of the method is depicted in FIG. 11. The residual water RW remaining on substrate 10, also residual gas, is shown after the degassing as a function of the substrate temperature T in degrees Celsius, the residual water RW being stated normalized (U.A. arbitrary units). Curve 26 shows the effect without gas according to prior art and curve 27 shows the effect according to the present invention utilizing the disposition with laminar gas streaming 16. As the carrier gas was used argon for the laminar gas streaming. It can be clearly seen that at temperatures starting at 150° Celsius with the present inventive disposition the residual gas is removed from the substrate significantly more effectively and on the substrate 10 consequently, with the same disposition and over the same length of time, significantly less residual gas remains.

The operating temperature of the degassing device or of the substrate 10 can be determined by the dwelling time of the water on the wafer surface and the desired process time to be achieved. Starting at 100° Celsius, favorable degassing values can be attained, at which the adsorbed substances on the substrate can be given off sufficiently rapidly in the laminar gas flow in order to be removed by it. The upper operating temperature is determined, on the one hand, by the feasibilities of embodiments in practice, on the other hand, by the permissibility of sensitive substrates and further by the benefit obtainable thereby. It was found, that a suitable upper temperature limit is at 400° Celsius. Above this temperature with the degassing device no significant improvement of the effect is achieved. As stated, for the setting up of the operating range for the gas flow it is essential that the parallel plate disposition of the heaters together with the substrate 10 makes laminar gas flow possible. It must, additionally, be ensured that over the process time a certain gas replacement rate in the interspace 28 of the plate-form bodies 11, 12 is attained. The gas replacement rate is herein the number of gas replacements, in which the content of the volume of the interspace 28 is completely replaced. The optimized gas flow range thereby becomes to a large extent dependent on the constructional formation of the configuration. Favorable configurations can be realized if the total gas flow is in the range of 300 sccm to 1000 sccm and the gas replacement rate is in the range of the 5 to the 15-fold at a process time of up to 30 s. To maintain a regime of laminar gas flow, an operating pressure of 10 to 50 mbar is necessary in this range. The lower limit is herein determined by the Knudsen molecular flow region. The upper limit is defined by the Reynolds number in the case of this geometry of the configuration. If the pressure is further increased, the regime of turbulent streaming becomes evident.

As stated, the laminar regime is highly preferred for optimal effect. The configuration is especially well suited for the degassing of semiconductor wafers, however, also for storage disks with a diameter greater than 150 mm, wherein these substrates are disk-form and have a thickness of tenths of millimeters up to millimeters. The configuration is especially well suited for disk diameters in the range of 150 to 300 mm. However, disks can also be worked which are greater than 300 mm, in this case the expenditure increases drastically and the results are less economical. The body distance d between the plate-form bodies 11, 12 is in the range of 5 to 30 mm, however, it is preferably to be selected between 8 to 15 mm in order to establish of a suitable laminar streaming. For handling the substrates it is favorable if the configuration is formed horizontally and the substrate 10 is placed onto the lower plate 11 and the upper plate 12 contains a gas jet with a heating disposition with a thermal power up to approximately 1200 W.

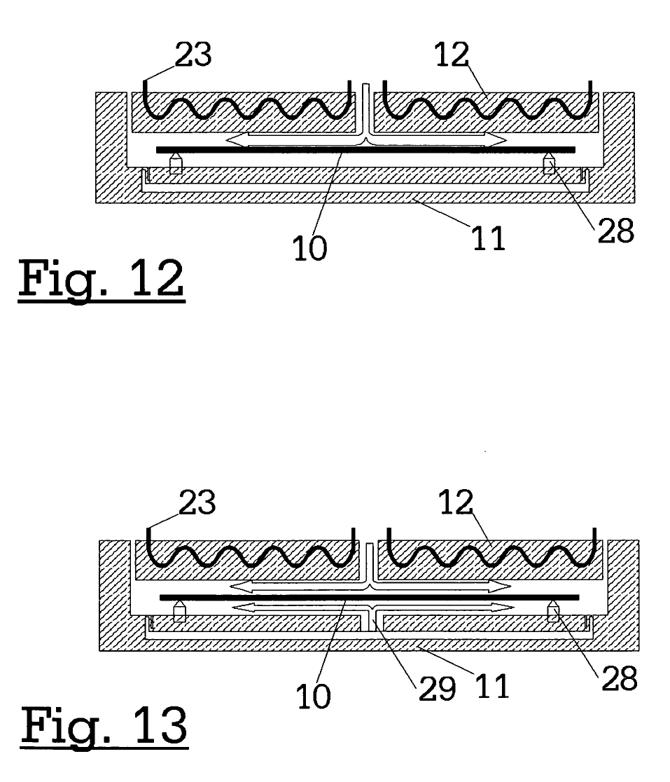

Referring to FIGS. 12 and 13, the substrate 10 is preferably positioned and supported by pins 28 respectively to create a gap between the substrate and lower chuck body 11. In consequence the substrate can be cleaned of adsorbents on both upper and lower sides thereof. This gap allows adsorbents from the bottom side to escape. The degassing of the lower bottom side can be enhanced by creating a similar laminar gas flow as over the top side. This lower gas flow 29 will effectively remove the adsorbents from the bottom. The combined device allows complete degassing of the substrate.

With the present configuration it is possible to realize a fully automated semiconductor working process facility which permits effective degassing between the individual process steps utilizing proven robot transport systems while attaining corresponding economic throughputs.

1. Device for degassing a plate-form substrate (10) in an evacuated environment with two substantially flat, parallel bodies (11, 12), spaced at a distance (d) smaller than their longitudinal extent (I) forming an interspace (28), with the substrate (10) located between the bodies (11, 12) and these projecting beyond the substrate at least in the margin region, characterized in that in at least one of the bodies (11,12) a gas delivery (13) is disposed for generating a laminar gas flow in the interspace (28) along the bodies (11, 12) and the substrate (10) in the radial direction toward the periphery of the bodies (11, 12) and that here a pumping port (14) is provided for pumping off the gas flow.

2. Device as claimed in claim 1, characterized in that a heating system (23) is provided for heating the substrate (10).

3. Device as claimed in claim 2, characterized in that the heating system (23) is formed as an electric heating element, preferably as a resistance heating element, and is preferably integrated in one of the bodies (11, 12) or in both bodies (11,12).

4. Device as claimed in claim 2, characterized in that the heating system (23) develops a temperature of 100° Celsius up to 400° Celsius on the substrate (10).

5. Device as claimed in claim 1, characterized in that the body distance (d) is in the range of 5 mm to 30 mm, preferably of 8 mm to 15 mm.

6. Device as claimed in claim 1, characterized in that the substrate diameter is greater than 150 mm, preferably 150 mm to 300 mm.

7. Device as claimed in claim 6, characterized in that the substrate (10) has the form of a disk, preferably is a storage disk, in particular a semiconductor wafer.

8. Device as claimed in claim 1, characterized in that the flat bodies (11, 12) are placed essentially horizontally and the substrate (10) is preferably deposited onto the subjacent disk-form body (11).

9. Device as claimed in claim 1, characterized in that the gas delivery (13) is located essentially centrally with respect to at least one of the bodies (11, 12), such that it leads into the interspace (28).

10. Device as claimed in claim 1, characterized in that the gas delivery is formed at least on one of the bodies (11, 12), preferably in the superjacent body (12), with several openings (18) for forming a gas jet.

11. Device as claimed in claim 10, characterized in that the openings (18) are distributed over the surface of a body (11, 12) and preferably have different opening diameters on the side facing the interspace (28).

12. Device as claimed in claim 1, characterized in that with respect to gas delivery (13), formation of the dimensions of the interspace (28) together with the pumping port (14) the device establishes in the interspace (28) a laminar gas streaming, wherein preferably within a process time of 30 s a gas replacement of the 5 to 15-fold is maintained.

13. Method for degassing a plate-form substrate (10) in an evacuated environment with two substantially flat parallel bodies (11, 12), spaced at a distance (d) smaller than their longitudinal extent (I) forming an interspace (28), and that a flat substrate (10) is disposed between the bodies (11, 12), characterized in that in at least one of the bodies (11, 12) a gas delivery (13) is located for the generation of a laminar gas flow in the interspace (28) along the bodies (11, 12) and the substrate (10) in the radial direction toward the periphery of the bodies (11, 12), and that here the gas flow is pumped off through a pumping port (14).

14. Method as claimed in claim 13, characterized in that the substrate (10) is heated with a heating system (23).

15. Method as claimed in claim 14, characterized in that the heating system (23) is operated as an electric heating element, preferably as a resistance heating element, and is preferably operated integrated in one of the bodies (11, 12) or in both bodies (11, 12).

16. Method as claimed in claim 14, characterized in that the substrate (10) is heated to a temperature of 100° Celsius to 400° Celsius.

17. Method as claimed in claim 13, characterized in that a body distance (d) in the range of 5 mm to 30 mm, preferably of 8 to 15 mm, is maintained.

18. Method as claimed in claim 13, characterized in that a substrate (10) with diameter greater than 150 mm, preferably in the range of 150 mm to 300 mm, is degassed.
